(19) United States
(12) Patent Application Publication
(10) Pub. No.: US 2008/0137958 A1
(43) Pub. Date: Jun. 12, 2008

(54) Method of utilizing mobile communication device to convert image character into text and system thereof

(75) Inventors: Chia-Yu Wang, Hsinchu (TW); Po-Lung Chen, Hsinchu (TW); Pei-Chun Chen, Hsinchu (TW); Ko-Shyang Wang, Hsinchu (TW); Chih-Chang Chen, Hsinchu (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsinchu (TW)

(21) Appl. No.: 11/707,833

(22) Filed: Feb. 16, 2007

(30) Foreign Application Priority Data
Dec. 6, 2006 (TW) 095145518

(51) Int. Cl. G06K 9/46; H04M 3/42

(52) U.S. Cl. 382/190; 455/414.1

(57) ABSTRACT

A method of utilizing a mobile communication device to convert image character into text and a system thereof are provided, which are utilized in a service to wirelessly transmit the image character captured by the mobile communication device to a server for being converted into an encoded text and then returned to the mobile communication device. The method includes the step of obtaining a digital image containing an image character; utilizing a wireless communication network to transmit the digital image into a server; extracting the area of the image character of the digital image; then, after recognizing and converting an image character program of the image character into a corresponding text, returning the text to the mobile communication device to be displayed, such that the problem of an inconvenient input operation when a large number of texts are input into the mobile communication device is solved.

### CROSS-REFERENCE TO RELATED APPLICATIONS

This non-provisional application claims priority under 35 U.S.C. §119(a) on Patent Application No(s).095145518 filed in Taiwan, R.O.C. on Dec. 6, 2006, the entire contents of which are hereby incorporated by reference.

### BACKGROUND OF THE INVENTION

1. Field of Invention

The present invention relate to a method of utilizing a mobile communication device to convert an image character into a text and a system thereof, and more particularly to, a method of utilizing a front-end mobile communication device to capture an image, transmitting the image to a back-end server for converting an image character into a text, and then returning the text and a system thereof.

2. Related Art

Currently, although a mobile phone or a personal digital assistant (PDA) provides a translation function, as the typing or hand-writing input speed of a mobile phone or PDA is still not ideal, or the interface is not convenient enough, the utilization of a mobile phone or PDA for inputting or editing a large number of characters is low. In addition, though a portable computer is relatively more convenient in input, the computer may not be always taken along when a user wants to collect data, especially outdoors. Therefore, persons in this field bring forth a technique of providing a specifically marked image by a front-end mobile device and utilizing a communication network to return the image to a back end for being processed through a network architecture. As shown in FIG. 1, U.S. Patent Publication No. U.S. Pat. No. 6,522,889 discloses that, by using a front-end mobile communication device 10, a geographical area image of a specific location is captured by a camera 11 disposed in the front-end mobile communication device 10; next, the image is transmitted through a wireless communication network of a general packet radio service (GPRS) network 12, and enters an internet 14 via an internet access 13; then, the image is converted by an optical character reader (OCR) server 15 linked to the internet 14 into a character type and compared with a geographical area database stored in a location server 16 also linked to the internet 14; afterward, a correct comparison position is returned to the mobile communication device 10.

The above technique provides an architecture of transmitting and processing an image through a network. However, the technique is merely used to capture an image of a specific geographical position by the front end and then locate the image by adding a recognition coordinate by the back end, and cannot quickly and easily input a large number of texts into a mobile communication device for collecting data.

### SUMMARY OF THE INVENTION

In view of the above disadvantages, to solve a technical problem, the present invention provides a data input method of capturing an image by a front-end mobile communication device, transmitting the image to a back-end server for being recognized and correspondingly converted into a text suitable for being encoded by a computer, and then returning the text. Moreover, to solve another technical problem, the present invention provides a system of randomly capturing a character image by a front end and obtaining a text thereof quickly, in which an image is captured by the front end, recognized and converted into a text, and then returned by a back end.

In the present invention, the technical means adopted by the method of utilizing a mobile communication device to convert an image character into a text are given below: obtaining a digital image containing an image character by a mobile communication device; utilizing a wireless communication network to transmit the digital image into a server; extracting the area of the image character of the digital image to form at least one character image to be recognized; recognizing and converting the character image to be recognized into a corresponding text in one language or a plurality of languages; utilizing a wireless communication network to transmit the text from the server back to the mobile communication device; and displaying the text in a display unit of the mobile communication device.

According to an improvement of the above invention, before the step of obtaining a digital image containing an image character by a mobile communication device, a step of displaying the sign of a border area in a display unit for designating the area of the digital image captured by the user, or displaying a marked sign for designating a position information in the digital image captured by the user is further comprised.

According to a further improvement of the present invention, in the step of obtaining a digital image containing an image character by a mobile communication device, after the digital image is completely recorded in a memory of the mobile communication device, a step of transmitting the digital image into a server, or a streaming transmission step of utilizing a wireless communication network to transmit the captured digital image into the server when capturing a portion of the digital image based on the streaming transmission technique is comprised.

The present invention is implemented by shooting an image with character to be inputted by the front-end mobile communication device, transmitting the image to the back-end server for being recognized and converted into a text, and then returning the resulted text to the mobile communication device for being displayed. Since the recent mobile wireless net-surfing becomes faster and faster, the time taken for transmission is not long, and the resolution of the image capture device on a mobile device is improved rapidly, the characters in an image can be effectively recognized. Moreover, by integrating the currently available stable and effective image processing technique and image character recognition technique, the powerful data storage and operation processing capabilities of a server can be combined with the convenience and mobility of a mobile communication device, such that the user can input texts more conveniently at any time any place, and the operation of the data collection of the digital texts can be performed effectively without the need to input by pressing keys by hand.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DISCREPTION OF THE DRAWINGS

The present invention will become more fully understood from the detailed description given herein below for illustration only, and thus is not limitative of the present invention, and wherein:

FIG. 1 is a system block diagram of a conventional art of recognizing the position of a mobile communication device;

FIG. 2 is a system block diagram of an embodiment of a system of utilizing a mobile communication device to convert an image character into a text according to the present invention;

FIG. 3 is a schematic flow chart of an embodiment of a method of utilizing a mobile communication device to convert an image character into a text according to the present invention;

FIG. 4 is a schematic flow chart of another embodiment of the method of utilizing a mobile communication device to convert an image character into a text according to the present invention, in which the digital image is captured in segments and the image is integrated before being recognized;

FIG. 5 is a schematic flow chart of yet another embodiment of the method of utilizing a mobile communication device to convert an image character into a text according to the present invention, in which the digital image is captured in segments and the image is integrated before being recognized;

FIG. 6 is a schematic block diagram in a single image capture embodiment of the method of utilizing a mobile communication device to convert an image character into a text according to the present invention;

FIG. 7 is a schematic block diagram in an embodiment of capturing an image in segments of the method of utilizing a mobile communication device to convert an image character into a text according to the present invention;

FIG. 8 is a schematic diagram of displaying the border area in the method of utilizing a mobile communication device to convert an image character into a text according to the present invention; and

FIG. 9 is a schematic diagram of displaying the marked sign of the user in the method of utilizing a mobile communication device to convert an image character into a text according to the present invention.

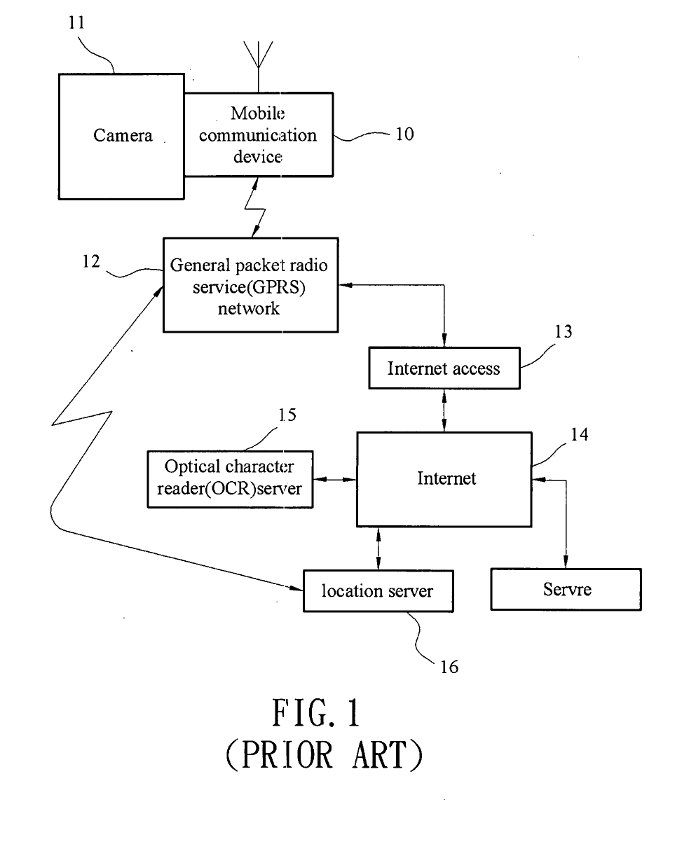

### DETAILED DESCRIPTION OF THE INVENTION

The preferred embodiments of the present invention are given below with reference to the drawings.

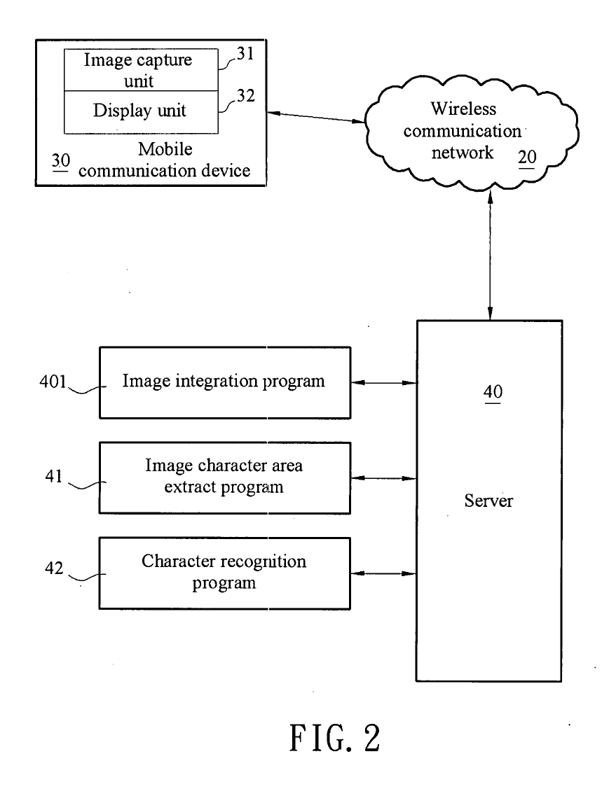

First of all, FIG. 2 is a system block diagram of an embodiment of a system of utilizing a mobile communication device to convert an image character into a text according to the present invention. The system includes a wireless communication network 20, a mobile communication device, and a server 40. The wireless communication network 20 usually refers to a mobile telecommunications protocol or mobile protocol, which can employ, but not limited to, wireless communication technologies, such as the second generation wireless communication technology (2G) including American standard GSM and European standard code-division multiple access (CDMA), the general packet radio service (GPRS) of the second and a half generation wireless mobile communication technology (2.5G), the third generation wireless mobile communication technology (3G), the third and a half generation wireless mobile communication technology (3.5G), personal handy-phone system (PHS), or wireless fidelity (WiFi), mainly for providing a wireless transmission platform of data. The mobile communication device 30 can be a device with data transmission function, such as a mobile phone, PDA, ultra mobile PC (UMPC), or notebook computers (NB). The mobile communication device 30 has an image capture unit 31 and a display unit 32. The image capture unit 31 can be a device such as a camera or a video camera, mainly used for capturing at least one digital image 33 containing an image character 331 and then transmitting the digital image 33 to the wireless communication network 20. The server 40 has an image character area extract program 41 and a character recognition program 42 which can be built in the server 40 or can be performed by the server 40 through network program serving. The server 40 is in communication with the wireless communication network 20, for extracting the area of the image character 331 from the digital image 33 uploaded by the mobile communication device 30, recognizing and converting the image character 331 into a text 421, then returning the text 421 to the mobile communication device 30 through the wireless communication network 20, and afterward displaying the content of the text 421 through the display unit 32 of the mobile communication device 30.

In the above embodiment, the server 40 further includes an image joint program 401 for integrating a plurality of digital images 33 in advance, and then transmitting the integrated image to the image character area extract program 41 to be processed.

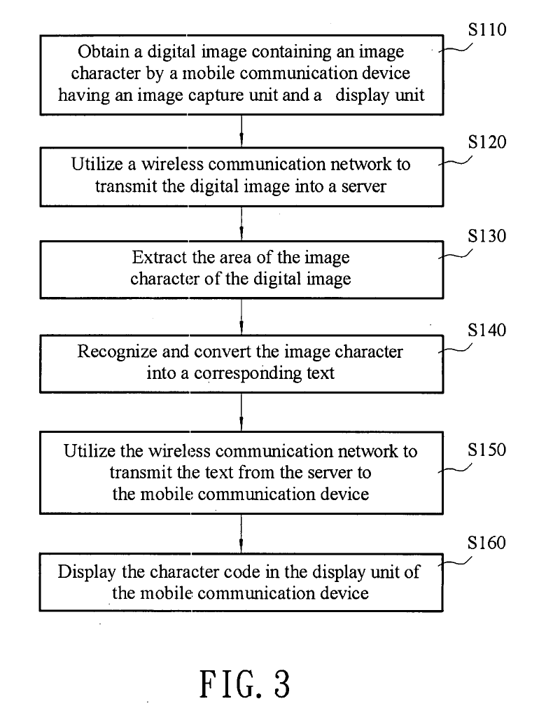

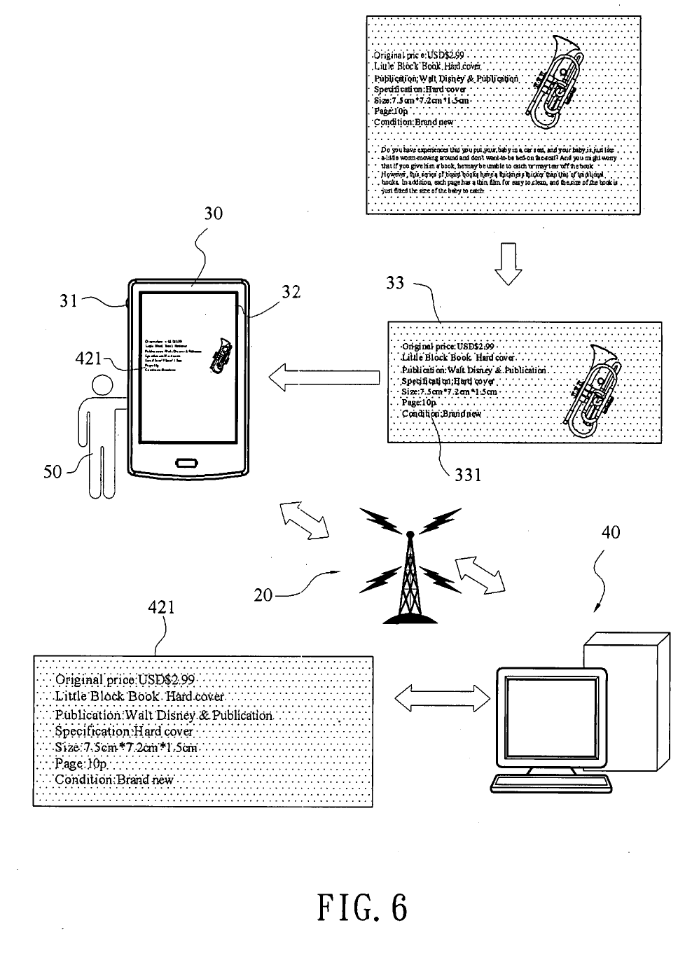

FIG. 3 is a schematic flow chart of an embodiment of the method of utilizing a mobile communication device to convert an image character into a text according to the present invention, and FIG. 6 is a schematic block diagram in a single image capture embodiment of the method of utilizing a mobile communication device to convert an image character into a text according to the present invention. The method includes: obtaining a digital image 33 containing an image character 331 by a mobile communication device 30, and the mobile communication device 30 has an image capture unit 31 and a display unit 32 (Step S110); utilizing a wireless communication network 20 to transmit the digital image 33 into a server 40 (Step S120); extracting the area of the image character 331 of the digital image 33 (Step S130); recognizing and converting the image character 331 into a corresponding text 421 (Step S140); utilizing the wireless communication network 20 to transmit the text 421 from the server 40 back to the mobile communication device 30 (Step S150); and finally, displaying the text 421 in a display unit 32 of the mobile communication device 30 (Step S160).

In the above embodiment, the recognition program also includes text data of multiple countries, such that the corresponding text 421 generated after the recognition can also include a plurality of languages.

In the above embodiment, before the step of obtaining a digital image containing an image character 331 by a mobile communication device 30, a step of displaying the sign of a border area 341 in the display unit 32 for designating the area of the digital image 33 captured by the user 50 is further included.

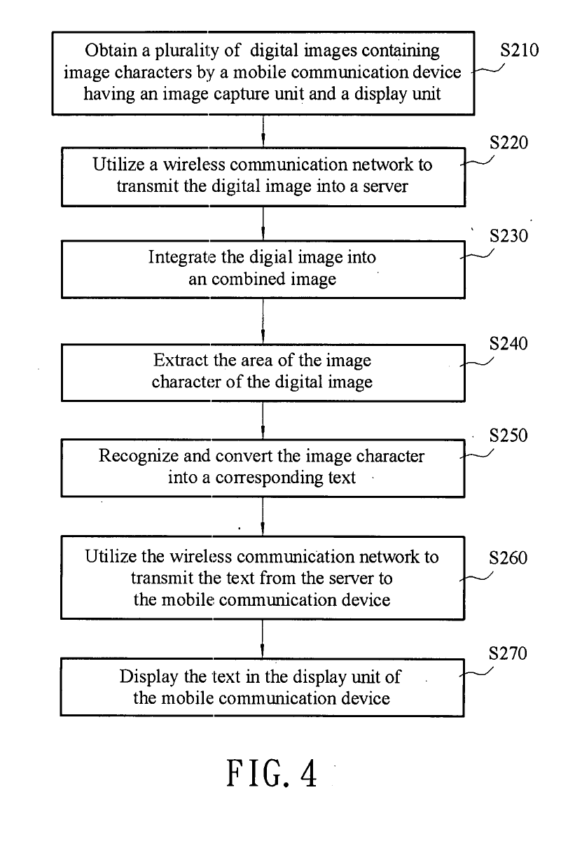

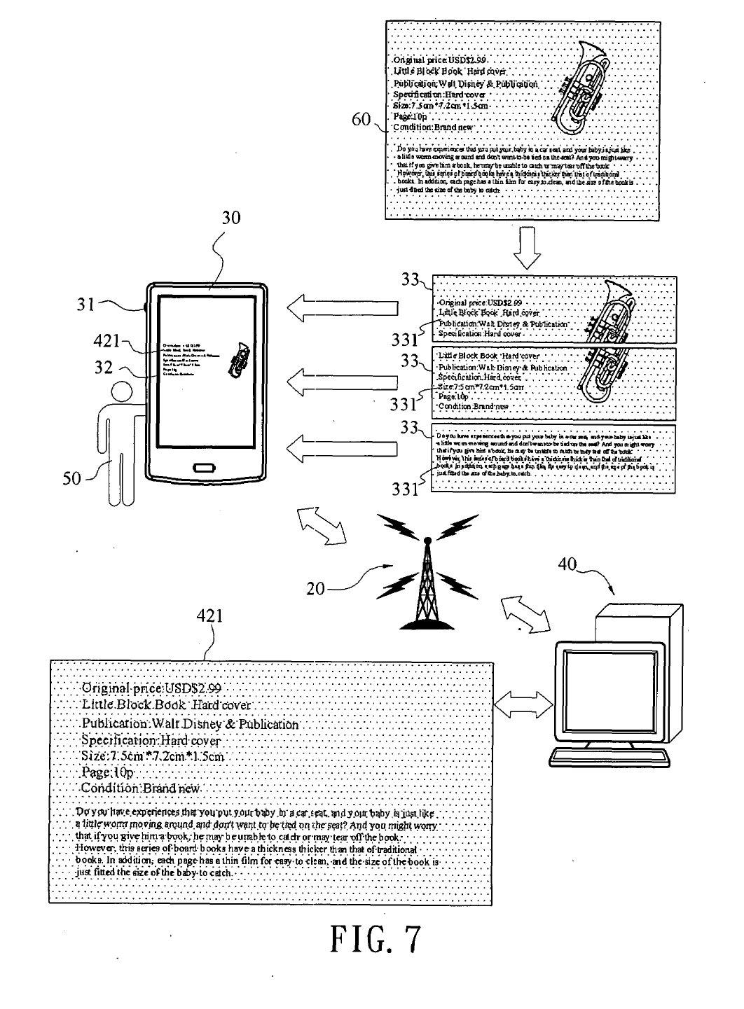

FIG. 4 is a schematic flow chart of another embodiment of the method of utilizing a mobile communication device to convert an image character into a text according to the present invention, in which the digital image is captured in segments and the image is integrated before being recognized. FIG. 7 is a schematic block diagram in an embodiment of capturing an image in segments of the method of utilizing a mobile communication device to convert an image character into a text according to the present invention. The method includes: obtaining a plurality of digital images 33 containing image characters 331 by a mobile communication device 30, and the mobile communication device 30 has an image capture unit 31 and a display unit 32 (Step 210); utilizing a wireless communication network 20 to transmit the digital images 33 into a server 40 (Step 220); integrating the digital images 33 into a combined image (Step 230); extracting the area of the image character 331 of the combined image (Step 240); recognizing and converting the image character 331 into a corresponding text 421 (Step 250); utilizing the wireless communication network 20 to transmit the text 421 from the server 40 back to the mobile communication device 30 (Step 260); and displaying the text 421 in a display unit of the mobile communication device 30 (Step 270). In this embodiment, an original image 60 with a character to be input in is captured in segments for several times by the mobile communication device 30, and when the segments are transmitted to the server 40, the extract and recognition steps are performed after the segments are integrated into the original image 60. This embodiment is advantageous in processing an image which is too large to be captured at a time or in improving the resolution of the captured image.

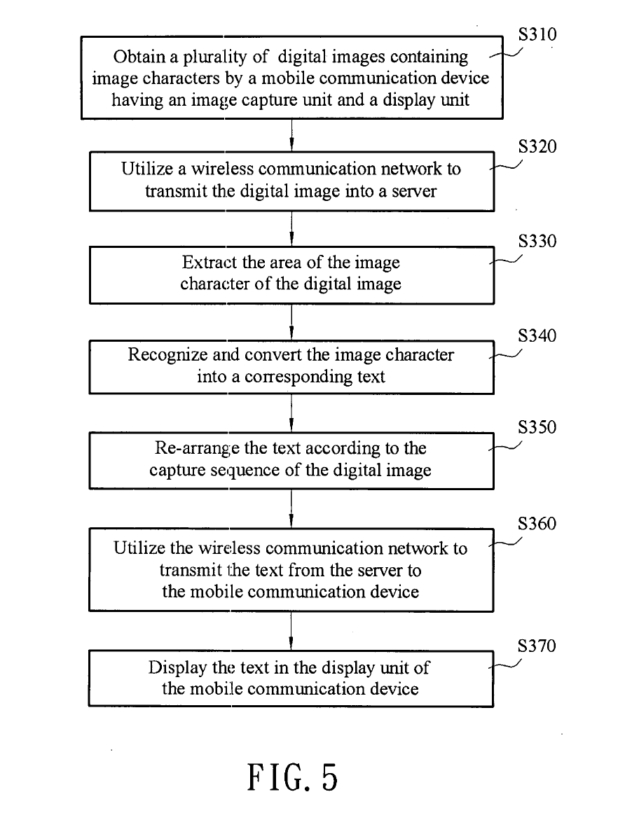

Then, referring to FIG. 5, a schematic flow chart of yet another embodiment of the method of utilizing a mobile communication device to convert an image character into a text according to the present invention, in which the digital image is captured in segments and the image is integrated before being recognized is shown. FIG. 7 is a schematic block diagram in an embodiment of capturing an image in segments of the method of utilizing a mobile communication device to convert an image character into a text according to the present invention. The method includes: obtaining a plurality of digital images 33 containing image characters 331 by a mobile communication device 30, and the mobile communication device 30 has an image capture unit 31 and a display unit 32 (Step S310); utilizing a wireless communication network 20 to transmit the digital images 33 into a server 40 (Step S320); extracting the area of the image character 331 of each digital image 33 (Step S330); recognizing and converting each image character 331 into a corresponding text 421 (Step S340); re-arranging the texts 421 according to the capture sequence of the digital images 33 (Step S350); utilizing the wireless communication network 20 to transmit the texts 421 from the server 40 back to the mobile communication device 30 (Step S360); and finally, displaying the texts 421 in a display unit 32 of the mobile communication device 30 (Step S370). In this embodiment, an original image 60 with character to be inputted is captured in segments for several times by the mobile communication device 30, and when the segments are transmitted to the server 40, after the extract and recognition steps are performed, the text 421 generated by recognition and conversion is re-arranged in the capture sequence and then returned. This embodiment is advantageous in processing an image which is too large to be captured at a time or in improving the resolution of the captured image and enhancing the accuracy of the character recognition.

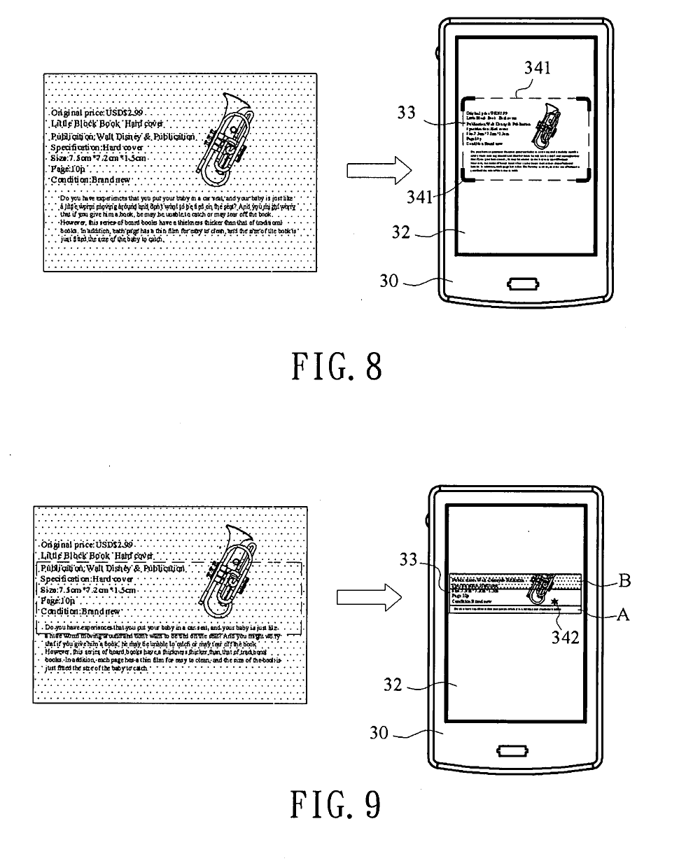

FIG. 8 is a schematic diagram of displaying the border area in the method of utilizing a mobile communication device to convert an image character into a text according to the present invention. In all the above embodiments, when the mobile communication device 30 captures a digital image 33, the sign of a border area 341 is displayed in the display unit 32 for designating the border range of the area of each digital image 33 captured by the user 50 (as, shown in FIG. 6 or 7). The range is also the range of the image processed after the digital image 33 is transmitted to the back-end server 40.

FIG. 9 is a schematic diagram of displaying the marked sign of the user in the method of utilizing a mobile communication device to convert an image character into a text according to the present invention. In the above embodiments of capturing an image in multiple times, before the step of obtaining a digital image 33 containing an image character 331 by a mobile communication device 30, a step of displaying a marked sign 342 marked by a user 50 (for example, as shown in FIG. 7) in a display unit 32 for designating a position information A on the direction of a digital image 33 captured in the next time. Since the second digital image 33 is captured by the user 50, an image B of an edge at the same side of the marked sign 342 of the previous digital image 33 is displayed in the display unit 32 at the same time, and the successive image segment identical to the edge image is included when the digital image 33 is captured, so as to enhance the accuracy of integrating the image by the image joint program 401 in the server 40 subsequently.

According to the above embodiments, the step of transmitting the digital image 33 by the mobile communication device 30 to the server 40 is followed by the digital image 33 is completely recorded in a memory of the mobile communication device 30, or by a performing a streaming transmission to transmit the captured digital image 33 into the server 40 when the mobile communication device 30 captures a portion of any of the digital images 33, so as to save the wireless transmission time for a relatively large digital image 33.

Moreover, in the above embodiments, after the step of recognizing and converting the image character into a corresponding text 421, a step of storing the text 421 into the server 40 is included, such that the user 50 can utilize the original communication network or another internet access, or a step of storing the text 421 into the server 40 is further included, such that the user 50 can download through the original wireless communication network 20 or an internet, such as a file transmission protocol serve, website server, or E-mail server, and the text 421 can be obtained by the user 50 through a networking device later on.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of utilizing a mobile communication device to convert image character into text, comprising:
obtaining a digital image containing an image character by the mobile communication device, wherein the mobile communication device has an image capture unit and a display unit;
utilizing a wireless communication network to transmit the digital image into a server;
extracting an area of the image character of the digital image;
recognizing and converting the image character into a corresponding text;
utilizing the wireless communication network to transmit the text from the server back to the mobile communication device; and
displaying the text in the display unit of the mobile communication device.

2. The method of utilizing a mobile communication device to convert image character into text as claimed in claim 1, wherein the text comprises texts of a plurality of languages.

3. The method of utilizing a mobile communication device to convert image character into text as claimed in claim 1, wherein before the step of obtaining a digital image containing an image character by a mobile communication device, a step of displaying a sign of a border area in the display unit for designating the area of the digital image captured by a user is further comprised.

4. The method of utilizing a mobile communication device to convert image character into text as claimed in claim 1, wherein in the step of obtaining a digital image containing an image character by a mobile communication device, a step of recording the digital image completely in a memory of the mobile communication device is further comprised.

5. The method of utilizing a mobile communication device to convert image character into text as claimed in claim 1, wherein in the step of obtaining a digital image containing an image character by a mobile communication device, a step of performing a streaming transmission to transmit the captured digital image into a server when a portion of the digital image is captured by the mobile communication device is comprised.

6. The method of utilizing a mobile communication device to convert image character into text as claimed in claim 1, wherein after the step of recognizing and converting the image character into a corresponding text, a step of storing the text into the server for being read by a user is further comprised.

7. A method of utilizing a mobile communication device to convert image character into text, comprising:
obtaining a plurality of digital images containing image characters by the mobile communication device, wherein the mobile communication device has an image capture unit and a display unit;
utilizing a wireless communication network to transmit the digital images into a server;
integrating the digital images into a combined image;
extracting an area of the image character of the combined image;
recognizing and converting the image character into a corresponding text;
utilizing the wireless; communication network to transmit the text from the server back to the mobile communication device; and
displaying the text in the display unit of the mobile communication device.

8. The method of utilizing a mobile communication device to convert image character into text as claimed in claim 7, wherein the text comprises texts of a plurality of languages.

9. The method of utilizing a mobile communication device to convert image character into text as claimed in claim 7, wherein before the step of obtaining a plurality of digital images containing image characters by a mobile communication device, a step of displaying a sign of a border area in the display unit for designating the area of each digital image captured by a user is further comprised.

10. The method of utilizing a mobile communication device to convert image character into text as claimed in claim 7, wherein before the step of obtaining a plurality of digital images containing image characters by a mobile communication device, a step of displaying a sign marked by a user in the display unit for designating a position information of a digital image to be captured in next time by the user is further comprised.

11. The method of utilizing a mobile communication device to convert image character into text as claimed in claim 10, wherein since the second digital image is captured by the user, an edge image at a same side of the marked sign of the previous digital image is displayed in the display unit at a same time, and a successive image segment identical to the edge image is comprised when the digital image is captured.

12. The method of utilizing a mobile communication device to convert image character into text as claimed in claim 7, wherein in the step of obtaining a plurality of digital images containing image characters by a mobile communication device, a step of recording the digital images completely in a memory of the mobile communication device is further comprised.

13. The method of utilizing a mobile communication device to convert image character into text as claimed in claim 7, wherein in the step of obtaining a plurality of digital images containing image characters by a mobile communication device, a step of performing a streaming transmission to transmit the captured digital images into a server when a portion of the digital image is captured by the mobile communication device is comprised.

14. The method of utilizing a mobile communication device to convert image character into text as claimed in claim 7, wherein after the step of recognizing and converting the image character into a corresponding text, a step of storing the text into the server for being read by a user is further comprised.

15. A method of utilizing a mobile communication device to convert image character into text, comprising:
obtaining a plurality of digital images containing image characters by the mobile communication device, wherein the mobile communication device has an image capture unit and a display unit;
utilizing a wireless communication network to transmit the digital images into a server;
extracting an area of the image character of each digital image;
recognizing and converting each image character into a corresponding text;
re-arranging the texts according to capture sequence of the digital images;
utilizing the wireless, communication network to transmit the texts from the server back to the mobile communication device; and
displaying the texts in the display unit of the mobile communication device.

16. The method of utilizing a mobile communication device to convert image character into text as claimed in claim 15, wherein the corresponding text comprises texts of a plurality of languages.

17. The method of utilizing a mobile communication device to convert image character into text as claimed in claim 15, wherein before the step of obtaining a plurality of digital images containing image characters by a mobile communication device, a step of displaying a sign of a border area in the display unit for designating the area of each digital image captured by a user is further comprised.

18. The method of utilizing a mobile communication device to convert image character into text as claimed in claim 15, wherein before the step of obtaining a plurality of digital images containing image characters by a mobile communication device, a step of displaying a sign marked by a user in the display unit for designating a position information of a digital image to be captured in next time by the user is further comprised.

19. The method of utilizing a mobile communication device to convert image character into text as claimed in claim 15, wherein since the second digital image is captured by the user, an edge image at a same side of the marked sign of the previous digital image is displayed in the display unit at a same time, and a successive image segment identical to the edge image is comprised when the digital image is captured.

20. The method of utilizing a mobile communication device to convert image character into text as claimed in claim 15, wherein in the step of obtaining a plurality of digital images containing image characters by a mobile communication device comprises, a step of recording the digital images completely in a memory of the mobile communication device is further comprised.

21. The method of utilizing a mobile communication device to convert image character into text as claimed in claim 15, wherein in the step of obtaining a plurality of digital images containing image characters by a mobile communication device, a step of performing a streaming transmission to transmit the captured digital images into a server when a portion of the digital image is captured by the mobile communication device is comprised.

22. The method of utilizing a mobile communication device to convert image character into text as claimed in claim 15, wherein after the step of recognizing and converting the image character into a corresponding text, a step of storing the text into the server for being read by a user is further comprised.

23. A system of utilizing a mobile communication device to convert image character into text, comprising:
a wireless communication network;
a mobile communication device, in communication with the wireless communication network, and having an image capture unit and a display unit, wherein the image capture unit is used for capturing at least one digital image containing an image character and transmitting the digital image to the wireless communication network; and
a server, in communication with the wireless communication network, and having an image character area extract program and a character recognition program, for performing an image character area recognition and character recognition on the digital image and converting the digital image into a text for being processed, then returning the text to the mobile communication device through the wireless communication network to be displayed by the display unit.

24. The system of utilizing a mobile communication device to convert image character into text as claimed in claim 23, wherein the server further comprises an image joint program.

25. The system of utilizing a mobile communication device to convert image character into text as claimed in claim 23, wherein the digital image is captured by a camera or a video camera.

26. The system of utilizing a mobile communication device to convert image character into text as claimed in claim 23, wherein the mobile communication device comprises a mobile phone, a personal digital assistant (PDA), an ultra mobile PC (UMPC), or a notebook computer (NB) capable of data communication.

27. The system of utilizing a mobile communication device to convert image character into text as claimed in claim 23, wherein the wireless communication network comprises a global system of mobile communication (GSM), a general packet radio service (GPRS), a personal handy-phone system (PHS), a code-division multiple access (CDMA) system, a 3G wireless mobile communication technology, or a wireless fidelity (WiFi).
